(19) United States
(12) Patent Application Publication
(10) Pub. No.: US 2007/0056217 A1
(43) Pub. Date: Mar. 15, 2007

(54) Tilt-latch and window sash assembly

(76) Inventor: Arthur Silverman, Warren, NJ (US)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 10/554,326

(22) PCT Filed: Apr. 30, 2003
(86) PCT No.: PCT/US03/13168

§ 371 Date: Jul. 14, 2006

(51) Int. Cl. E05D 15/22

(52) U.S. Cl. 49/185; 49/183; 49/176

(57) ABSTRACT

A window assembly is disclosed that allows a person to easily clean the exterior side of a windowpane, and prolongs the life of the window assembly. A window assembly (200) according to the present invention comprises a fixed window frame (202), tilt-latch assemblies (1, 2), and upper and lower window sashes (203, 204) comprised of a plurality of window sash rails, wherein each window sash rail has an outer wall (302), a front wall (300), and a rear wall (304). The tilt-latch assemblies (1, 2) secure the upper and lower window sashes (203, 204) within the fixed window frame (202). The tilt-latch assembly (1) is inserted into a slot (301) that is located on the outer wall (302) of the window sash rail for receiving a tilt-latch assembly (1). A lip (314) is located between a corner edge (212), wherein two sash rails meet to form a corner, and the outer edge (310) of the slot (308). The (314) can help prevent stress failure of the window sash rail.

### TECHNICAL FIELD

The present invention relates to a tilt-latch assembly for use in a window sash. More particularly, it relates to a new and improved window sash and tilt-latch assembly for more effectively securing the window sash in a window frame.

### BACKGROUND ART

Certain types of window assemblies commonly comprise a fixed window frame, with a window sash that slides vertically along guide rails on the fixed window frame. Such window sashes are generally rectangular in shape with a top sash rail, and a bottom sash rail, and two side sash rails having grooves that fit within the guide rails of the fixed window frame.

Many window sashes are constructed so as to be able to pivot (or tilt) out of a fixed window frame in order to enable greater ease in cleaning the glass windowpanes or window units of the window sashes. To permit the pivoting of a window sash out of a fixed window frame, or alternatively to secure the window sash in place, it is well known in the art to mount tilt-latch assemblies on, or in, opposed ends of the window sash top rail.

As is known to those skilled in the art, tilt-latch assemblies typically comprise a mounting member that houses the individual components of the tilt-latch assembly. The mounting member is mounted into the window sash so as to secure the tilt-latch assembly in the window sash. It has one open end, and a latch or slide member disposed within the mounting member so as to allow the latch member, in its extended position, to protrude through both the open end of the mounting member, and extend beyond the side of the window sash. The latch member is also constructed and arranged so as to be received by the fixed window frame in a suitable manner in order to secure the window sash in a fixed window frame. Conversely, release of the window sash from the fixed window frame is accomplished when the latch member is retracted into the mounting member.

Tilt-latch assemblies are typically secured to the top rail of a window sash by sliding them into opposing slots located on the top rail of a window sash. Prior art FIG. 1 shows one typical configuration of the corner 106 of window sash 102 for receiving a tilt-latch assembly. The window sash 102 has an open-ended slot 104 located on the top rail 100 at the corner 106 of the window sash 102. As seen, this type of opening conveniently allows for the horizontal insertion of a tilt-latch assembly into the open-ended slot 104.

Although convenient for the horizontal insertion of the tilt-latch into a window sash, stress testing has shown that the prior art design of locating the open-ended channel at the outermost edges of the window sash can weaken the window sash. Especially in conditions of high wind, a considerable amount of pressure can be exerted onto the sliding member which engages the fixed window frame. Stress testing shows that under such conditions, the corners of the window sash can open up and stress failure can occur.

### SUMMARY OF THE INVENTION

The present invention overcomes the shortcomings of. the prior art by providing a window assembly that is better able to prevent stress failure and prolong the life of the window assembly. Various window assemblies in accordance with the present invention are disclosed which prevent or minimize the stress failure of window sash assemblies that comprise part of the window assembly. In addition, improved tilt-latch assemblies are disclosed that comprise part of the window assembly of the present invention, and are secured within the window sash.

According to one aspect of the present invention, there is provided a window assembly which comprises a window frame, a plurality of sash rails joined together to form a window sash, and a tilt-latch assembly. Each sash rail is comprised of a front wall, a rear wall, and an outer wall. A first sash rail and a second sash rail are connected to each other so as to form a corner. The outer wall of the first sash rail has a slot therein disposed a predetermined distance away from the corner to provide a lip. The lip reinforces the outer wall and holds together the front wall and rear wall, so as to help prevent displacement of the front wall and rear wall. The tilt-latch assembly is arranged and constructed to be mounted in the slot.

In accordance with a preferred embodiment of this aspect of the invention, the tilt-latch assembly is comprised of a mounting member and a latch or slide member. The mounting member has a top plate having a first and a second side. First and second spaced parallel walls project from the second side of the top plate to define a channel. Additionally, the latch member is disposed within the channel to allow sliding movement relative to the top plate of the mounting member to engage the window frame.

In accordance with a further embodiment of this aspect of present invention, the latch member comprises an angular nose that engages the window frame. Preferably, the angular nose is of an increased thickness relative to the thickness of the body of the latch or slide member in order to better distribute the stresses exerted by the latch member on the window frame.

In accordance with a still further embodiment of this aspect of the present invention, the tilt-latch assembly further comprises a control knob that controls movement of the latch member relative to the mounting member.

In accordance with a further embodiment of this aspect of the present invention, a notch is located on each of the spaced parallel walls to receive the lip of the outer wall of the window sash. The notch helps to secure the tilt-latch assembly within the outer wall.

In accordance with a still further embodiment of this aspect of the present invention, at least one tab is positioned on the first parallel wall in order to secure the tilt-latch assembly in the outer wall of the window sash rail. Additional tabs can be positioned on the spaced parallel walls and/or the end wall joining the first and second parallel walls.

In accordance with another aspect of the present invention, a window sash and at least one tilt-latch assembly for releasably retaining said window sash in a window frame are disclosed. The window sash comprises at least one horizontal sash rail and at least one vertical sash rail, wherein the at least one horizontal sash rail and at least one vertical sash rail are connected to form a corner. The horizontal sash rail comprises a front wall, a rear wall, and an outer wall. Additionally, a slot is located on the outer wall of the at least one horizontal sash rail to receive the tilt-latch assembly. The slot is disposed a predetermined distance away from the corner in order to provide a lip between the corner and the slot. The lip reinforces the outer wall to hold together the front wall and the rear wall. The tilt-latch assembly is arranged and constructed so that it may be mounted and secured in the slot. The tilt-latch assembly also has a latch member that extends beyond the second sash to engage the window frame.

These and other features and characteristics of the present invention will be apparent from the following detailed description of preferred embodiments which should be read in light of the accompanying drawings in which corresponding reference numbers refer to corresponding parts throughout the several views.

### BRIEF DESCRIPTION OF THE DRAWINGS

FIG. 1 is a partial perspective view of a prior art window sash.

FIG. 2 is a perspective view of a window assembly according to the present invention comprising a window frame and a pair of window sashes which each have a pair of tilt-latch assemblies disposed therewithin.

FIG. 3 is a perspective view of a portion of a window sash and a tilt-latch assembly in accordance with the present invention.

FIG. 4 is an exploded perspective view of the unassembled components of the tilt-latch assembly shown in FIG. 3.

FIG. 5 is a perspective view of the underside of the mounting member of the tilt-latch assembly shown in FIG. 3.

FIG. 5A is a perspective view of the top side of the mounting member component shown in FIG. 5.

FIG. 5B is a perspective view of an alternative embodiment of the mounting member component.

FIG. 6 is a bottom perspective view of a tilt-latch assembly in accordance with the present invention, with the bottom wall of the mounting member removed for illustrative purposes.

FIG. 7 is a side elevational view of a preferred embodiment of a control knob used in the tilt-latch assembly of FIG. 3.

FIG. 8 is a top view of the control knob shown in FIG. 7.

FIG. 9 is a side view of an alternate embodiment of a control knob for use in a tilt-latch assembly in accordance with the present invention.

FIG. 10 is a top view of another alternative embodiment of a control knob component.

FIG. 11 is a bottom view of the latch member component of the tilt-latch assembly shown in FIG. 3.

FIG. 12 is a perspective view of a tilt-latch assembly mounted in a window sash in accordance with the present invention, and which is partially broken away for illustrative purposes.

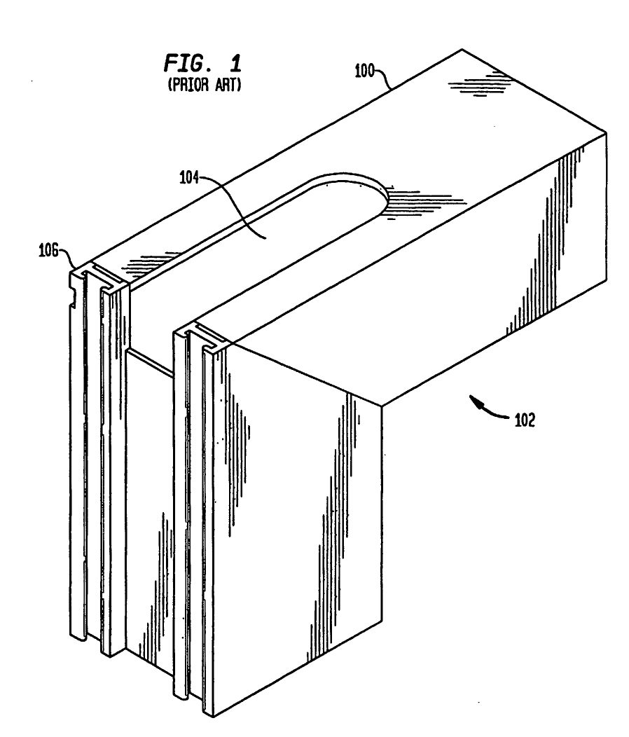

### BEST MODE OF CARRYING OUT INVENTION

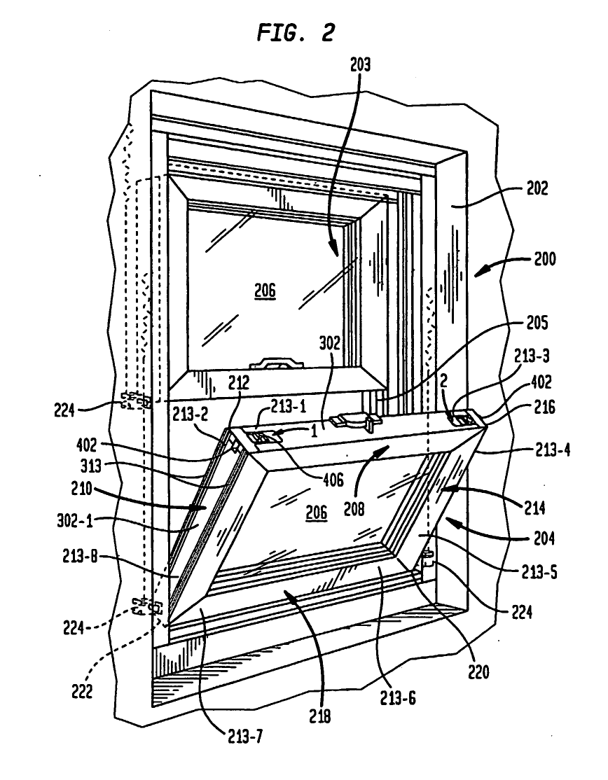

The present invention is generally directed to a window assembly 200, such as the double-hung window assembly shown in FIG. 2. The window assembly 200 is preferably comprised of a fixed window frame 202, an upper window sash 203, and a lower window sash 204, both containing a glass window unit or windowpane 206. Each of the window sashes 203, 204 have a pair of tilt-latch assemblies 1,2 that secure the upper window sash 203 and lower window sash 204 within the fixed window frame 202. The fixed window frame 202 has opposed vertically extending guide rails 205. The tilt-latch assemblies 1,2 are located on opposed ends of the upper and lower window sashes 203, 204 and extend into the fixed window frame 202. While the present invention will be described primarily with respect to a double-hung window assembly, it should, however, be appreciated that the present invention can be used in connection with various other types of pivotal windows or structures including, but not limited to, a hopper window assembly, a vertical pivot window assembly, and the like, wherein it is desired to prolong the life of a window assembly.

Each window sash 203, 204 comprises a plurality of sash members joined together at their respective ends. As shown in FIG. 2, a first horizontal sash rail 208 is joined at a first end 213-1 by a second end 213-2 of the first vertical sash rail 210 to form a first corner 212. At its second end 213-3, the first horizontal sash rail 208 is joined by the first end 213-4 of a second vertical sash rail 214 to form a second corner 216. The second end 213-5 of the second vertical sash rail 214 is joined by the first end 213-6 of a second horizontal sash rail 218 to form a third corner 220. A fourth corner 222 is formed where the second end 213-7 of the second horizontal sash rail 218 and the first end 213-8 of the second vertical sash rail 210 meet.

The upper window sash 203 and lower window sash 204 are each mounted for vertical movement along adjacent parallel grooves 205. Because it is difficult for a person located inside a building to reach the exterior side of the window unit 206, each of the window sashes 203, 204 is constructed and arranged so as to be capable of being pivoted away from the fixed window frame 202 to enable easy cleaning of the exterior side of the window unit 206. Specifically, the lower window sash assembly 204 has a pivot mechanism 224 at its third corner 220 and fourth corner 222 for mounting the lower window sash 204 for vertical sliding movement in the groove 205. The pivot mechanism 224 permits the lower window sash 204 to pivot inwards to allow a user to easily reach and clean the exterior side of the window unit 206. The upper window sash 203 likewise has a pivot mechanism 224 at its lower corners (not all shown) for mounting the upper window sash 203 for vertical sliding movement in its respective grooves 205 and inward pivoting movement to allow a user to easily reach and clean the exterior side of the window unit 206. In this respect, the lower window sash 204 can be tilted out of the frame first for cleaning, with the upper window sash 203 then tilted out of the fixed window frame 202 to lie over the lower window sash 204. After cleaning, each of the window sashes 203, 204 are tilted back into the window frame 202 and ready for normal use.

While the present invention is preferably employed with both the upper and lower window sashes 203, 204, it will be discussed hereinafter with reference to a lower window sash 204. It will be understood that the use of the present invention with an upper window sash 203 is essentially the same as with a lower window sash 204.

The lower window sash 204 is in a non-pivoted or closed position when it rests within the guide rails 205 of the fixed window frame 202. The lower window sash 204 is secured, in part, by latch or slide members 402 that are located within the tilt-latch assemblies 1, 2 and protrude beyond the first corner edge 212 and second corner edge 216 of the window sash 204, as well as beyond the second end 213-2 of the first vertical sash rail 210, and the first end 213-4 of the second vertical sash rail 214. The latch or slide members 402 engage the fixed window frame 202, so as to prevent the pivoting motion of the lower window sash 204 about the pivot mechanism. The lower window sash 204 may be moved to a pivoted or open position when the latch or slide members 402 are retracted into the tilt-latch assemblies 1, 2 in the lower window sash 204 such that the latch or slide members 402 no longer engage the fixed window frame 202. That is, retraction of the latch or slide members 402 out of the guide rails 205 and into the lower window sash 204 permits the window sash 204 to be free to pivot away from the fixed window frame 202. This pivoting of the lower window sash 204 is best seen in FIG. 2.

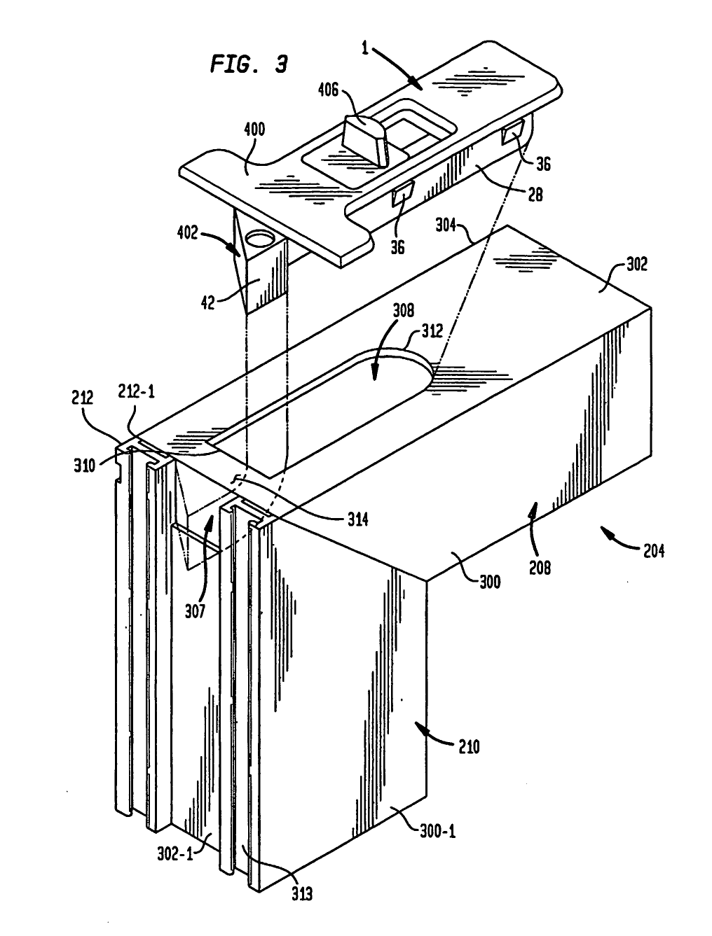

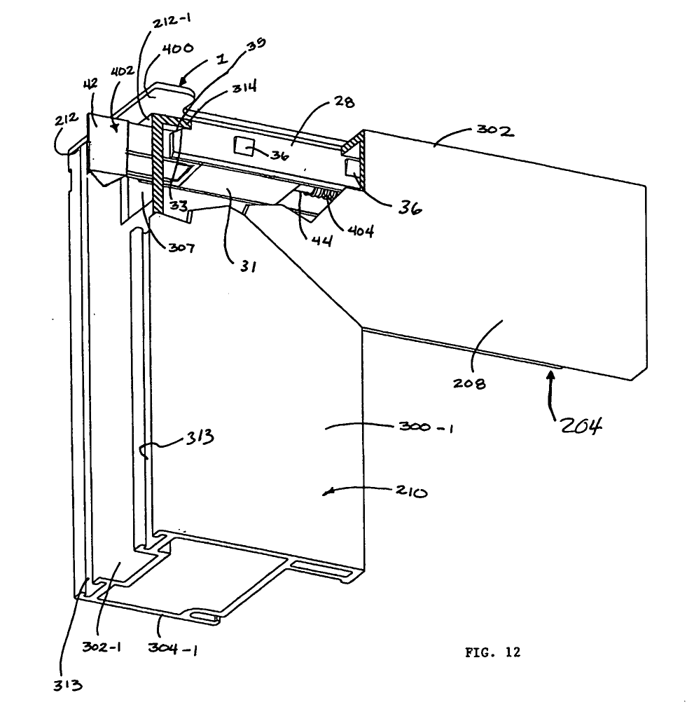

As shown in FIG. 3, which illustrates a portion of the lower window sash 204, the first horizontal sash rail 208 is comprised of an outer or top wall 302 connected to a front wall 300 and a rear wall (not shown) 304. As best shown in FIG. 12, together the walls 300, 302 and 304 create a hollow passageway 307 in the first horizontal sash rail 208, which will ultimately receive the tilt-latch assembly 1. It should be appreciated that the passageway 307 does not have to be hollow, but rather need only be adapted to receive the tilt-latch assembly 1.

As also shown in FIGS. 3 and 12, the first vertical sash rail 210 also comprises a front wall 300-1, an outer wall 302-1, and a rear wall 304-1 (see FIG. 12). However, the first vertical sash rail 210 preferably has T-slots 313 which are used to receive wool pile strips for sealing of the window sashes 203, 204 in the fixed window frame 202. An inner edge 212-1 of the outer wall 302 is preferably displaced inwardly from the corner 212 to provide access to the T-slots 313 for insertion of wool pile strips.

As shown in FIG. 3, in order to secure the tilt-latch assembly 1 in the lower window sash 204, the tilt-latch assembly, 1 is inserted into the hollow passageway 307 of the first horizontal sash rail 208 through a slot 308, which is located on the outer wall 302. The slot 308 has an inner slot edge 312 and an outer slot edge 310 that is arranged close to but away from the edge of the corner 212, and preferably from the inner edge 212-1. According to an important feature of the present invention, the slot 308 is located a predetermined distance away from the first corner 212 to define a lip 314. The lip 314 separates the slot 308 and the first corner 212. Where the outer wall 302 is displaced from the corner 212, as in the embodiment shown in FIG. 3, the lip 314 also separates the slot 308 from the inner edge 212-1.

As also shown in FIG. 3, the lip 314 provides an important advantage of the present invention. The lip 314, according to the present invention, serves to reinforce the outer wall 302, such that it is able to withstand forces exerted onto the first horizontal sash rail 208 by the latch or slide member 402 and fixed window frame 202. Such reinforcement helps to prevent or at least minimize stress failure from occurring at the location of the first corner 212 by preventing the outer wall 302, front wall 300 and rear wall 304 from lateral and vertical displacement. The lip 314 of the present invention thus reinforces the outer wall 302 and ultimately helps to hold the front wall 300 and rear wall 304 together. This greatly contrasts with the prior art, wherein the absence of such a lip predicated the premature failure at the first corner 212 and the displacement of the front wall 300 and rear wall 304. Indeed, prior art window sashes can be susceptible to such displacement at their respective corners.

The width of the lip 314 in the preferred embodiment shown in FIG. 3 is the distance taken from the inner edge 212-1 of the outer wall 302 to the outer slot edge 310 of the slot 308. The lip 314 can take on a variety of widths. As shown in FIG. 3, the lip 314 must be spaced away from the inner edge 212-1 of the outer wall 302 of the first horizontal sash rail 208 so that it can reinforce the outer wall 302 of the first horizontal sash rail 208. According to a preferred embodiment, the width of the lip is between about 0.5 and about 0.75 inches, and more preferably about 0.625 inches. However, the width of the lip 314 can be as small as 0.25 inches or smaller, depending on the wall thickness and the size of the window sash rail 208. Also, the width of the lip 314 can be larger than about 0.75 inches.

The tilt-latch assemblies 1,2 (as seen in FIG. 2) must be constructed and arranged so as to be capable of being received and secured in the outer wall 302 of the first horizontal sash rail 208 (see FIG. 3). For ease of continued discussion, however, reference will only be made to the tilt-latch assembly 1.

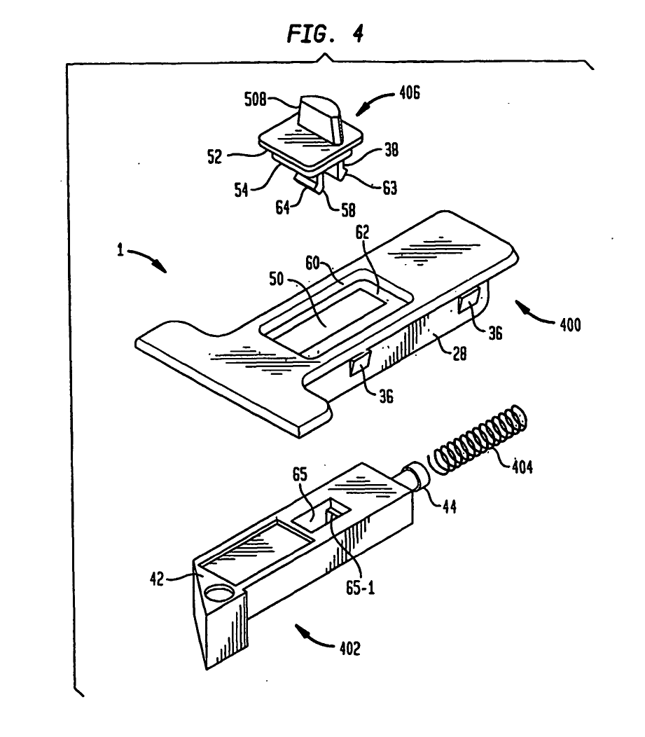

A tilt-latch assembly 1 can be comprised of any number of components, but in a preferred embodiment, as seen in FIG. 4, the tilt-latch assembly 1 is comprised of a mounting member 400, a latch or slide member 402, a spring 404, and a control knob 406.

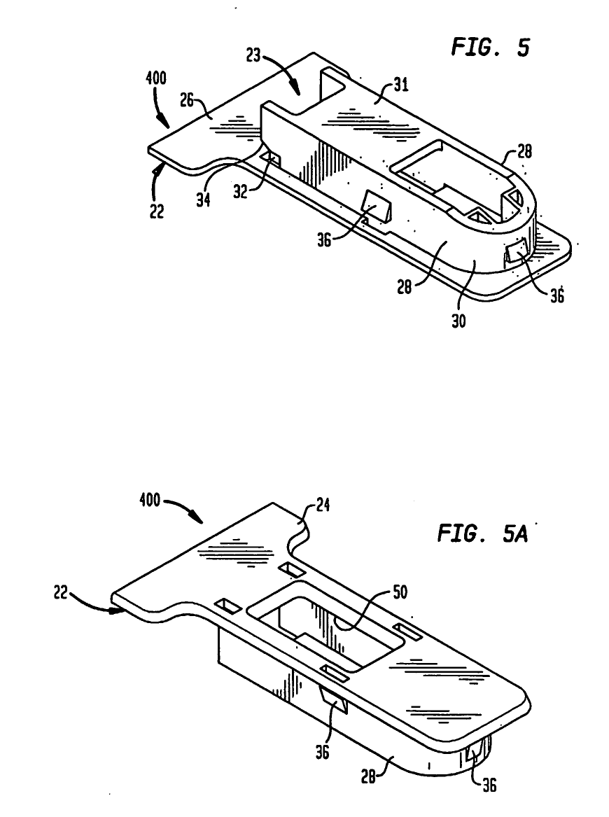

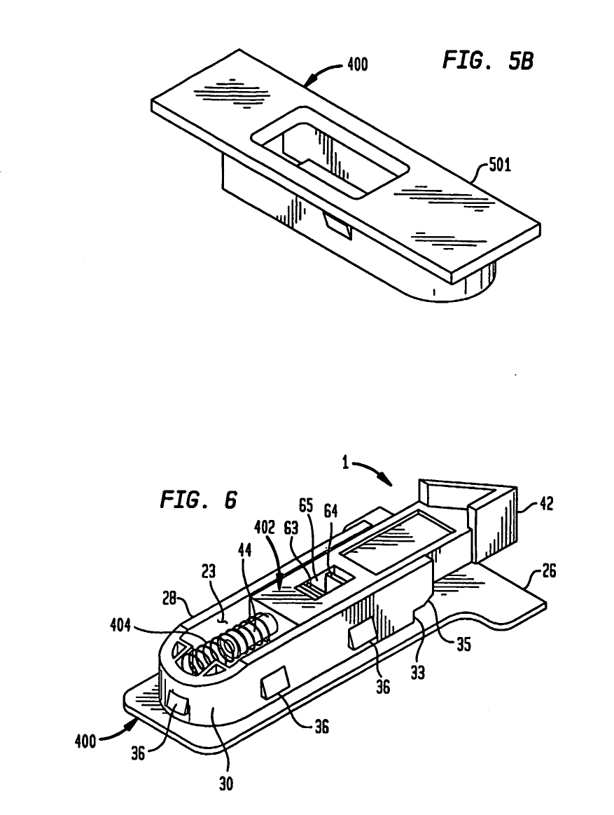

As seen in FIGS. 5 and 5A, the mounting member 400 has a top plate 22 with a first side 24 (as seen in FIG. 5A) and a second side 26 (as seen in FIG. 5). The top plate 22 is preferably in the shape of a “T”, although different shapes may be utilized. As shown in FIG. 12, the T-shaped portion of the mounting member 400 is designed to rest on top of the lip 314 of the outer wall 302, and extend over so as to cover the T-slots 313 present in the first vertical sash rail 210. (The T-slots 313 are used to receive a wool pile strip for sealing of the window sashes 203, 204 in the window frame 202.) In an alternative embodiment, as shown in FIG. 5B, a square top plate 501 may be used.

As best shown in FIG. 5, spaced parallel sides 28 project from the second side 26 of the top plate 22 to form a channel 23. The spaced parallel sides 28 are preferably located inwardly from the outer edges of the second side 26. A semi-circular end section or end wall 30 joins the spaced parallel sides 28, although the spaced parallel sides 28 can meet to form any shape, such as a square. It is preferred that a bottom channel plate 31 connects the spaced parallel sides 28 of the mounting member 400, such that the mounting member 400 is closed or at least partially closed.

Another important feature of the present invention is shown in FIGS. 5 and 6, (In FIG. 6, the bottom channel plate has been removed for illustrative purposes.) Specifically, the spaced parallel sides 28 have notches 32, 33 closest to the second side 26 of top plate 22 for receiving the lip 314 of the outer wall 302. The notches 32, 33 help prevent the tilt-latch assembly 1 (as seen in FIG. 3) from being forced upward out of the slot 308. Preferably, the notches 32, 33 have angled edges 34, 35 to help facilitate insertion of the tilt-latch assembly 1 into the slot 308 in the outer wall 302 of the first horizontal sash rail 208, although such angled edges are not necessary. As shown in FIG. 3, the slot 308 of the outer wall 302 should be arranged and constructed so as to be capable of receiving the spaced parallel sides 28 of the mounting member 400. Preferably, the shape of the slot 308 will correspond and conform to the shape of the spaced parallel sides 28 to help reduce movement of the tilt-latch assembly 1 while positioned in the slot 308. According to a preferred embodiment of the present invention, the slot 308 has one square end and one semi-circular end that correspond to the spaced parallel sides 28 and the semi-circular end wall 30 of the tilt-latch assembly 1.

As shown in FIGS. 4 and 6, a latch or slide member 402 is disposed between the spaced parallel sides 28 of the mounting member 400. The latch member 402 is an elongated piece that preferably has an angled nose 42 at one end and a stem 44 projecting from its opposite end. The angled nose 42 is preferably of increased thickness in comparison to the height of the spaced parallel sides 28 defining the channel 23. More preferably, the height or thickness of the angled nose 42 is approximately equal to the spacing between the sides 28 defining the channel 23. The stem 44 is capable of receiving a biasing means, such as a spring 404 for biasing the latch member 402 toward its extended or latching position. When the latch member 402 is supported in the mounting member 400, the spring 404 is positioned between the inside surface of the semi-circular wall 30 and the stem 44 on the latch member 402 (see FIG. 6).

As shown in FIGS. 3 and 12, the latch or slide member 402, in its extended position extends beyond the lip 314 and first corner edge 212 of the window sash 204 (see also FIG. 2). Accordingly, the nose 42 of the latch member 402 will be received by the fixed window frame 202 (as seen in FIG. 2). While in this stationary position, the lower window sash 204 is secured within the fixed window frame 202 for vertical sliding movement. It should be appreciated that the latch member 402 is not required to immediately overly the lip member 314, but a space may exist between the lip 314 and the latch member 402.

As shown in FIG. 2, the lower window sash 204 may be released from the fixed window frame 202 when the latch member 402 is retracted a sufficient distance away from the fixed window frame 202 and into the mounting member 400 (see FIGS. 5 and 5A) in lower window sash 204. In the tilt-latch retracted position, the lower window sash 204 is free to pivot out of the fixed window frame 202.

As shown in FIGS. 3, 4 and 7, retraction of the latch member 402 is controlled by a control means such as a control knob 406. The control knob 406 is capable of retracting the latch member 402 into the mounting member 400 when pressure is properly exerted on the control knob 48, preferably in a horizontal direction. It should be appreciated that other control means may be used to control the latch member 402.

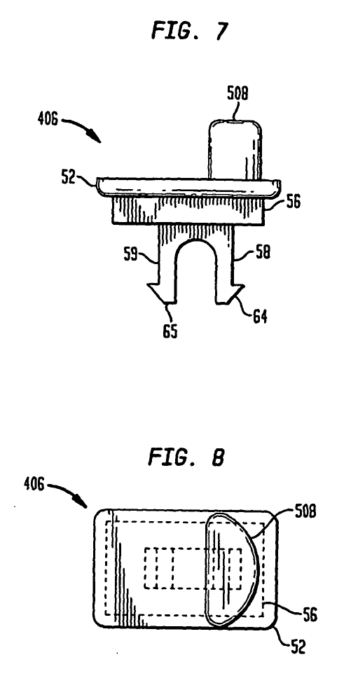

As shown in FIGS. 7 and 8, the control knob 406 preferably has an operator button 508. The operator button 508 can be of any shape, but in a preferred embodiment, it is semi-circular in shape. As best seen in FIG. 7, the operator button 508 is attached to a control knob plate 52. In a preferred embodiment, a control knob stem platform 56 is located below the control knob plate 52, and control knob stems 58, 59 project from the control knob stem platform 56. Alternatively, the control knob stems 58, 59 can project directly from the control knob plate 52.

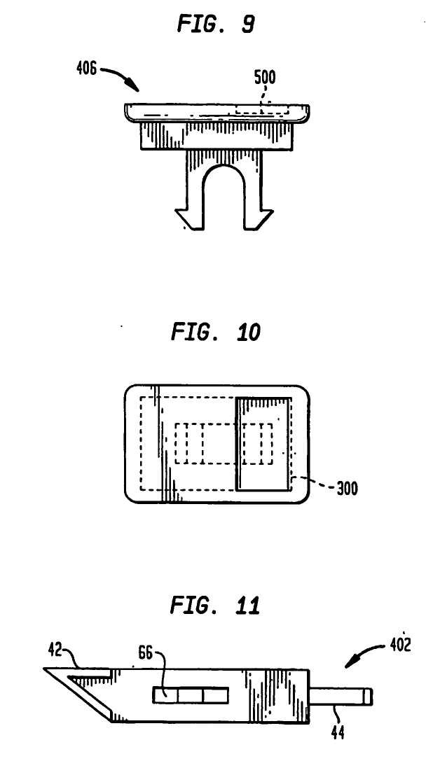

In another alternative embodiment, as shown in FIGS. 9-10, the control knob 406 may comprise an indentation 500 on the control knob plate 52, as opposed to a separate protruding member. Such a construction and arrangement should also simplify the manufacture of the control knob, as there is no need to construct a protruding member.

As shown in FIG. 4, the mounting member 400 is further constructed so as to have an opening 50 for receiving the control knob 406. In a preferred embodiment, the opening 50 preferably has a first ridge 60 and a second ridge 62. The control knob plate 52 will rest on the first ridge 60 and the control knob stem platform 56 will rest on the second ridge 62. The control knob stems 58, 59 fit through the opening 50 of the mounting member 400 and are received by a latch member opening 65 located on the latch member 402. In a preferred embodiment, the latch member opening 65 has a top ridge 65-1 (see FIG. 4) and a bottom ridge 66 (see FIG. 11). As best seen in FIGS. 4, 6, when the control knob 406 is received by the latch member opening 65, feet 63, 64 located at the ends of control knob stems 58, 59 reach over the bottom ridge 66 to secure the control knob 406 in place. It should be appreciated that the control knob 406 may instead be secured in any other suitable manner, such as by adhesives or screws.

As shown in FIG. 3, in order to mount the tilt-latch assembly 1 into the nose 42 of the tilt-latch assembly 1 is preferably inserted first into the slot 308. As seen in FIG. 12, the notches 32, 33 (not shown) on the mounting member 400 receive the lip 314, and the second side 26 of the mounting member 400 rests on top of the outer wall 302. The tilt-latch assembly 1 can be held in place by tabs 36 which are located on the exterior surface of spaced parallel sides 28 (see FIGS. 4, 5, 5A and 6). The tabs 36 allow the tilt-latch assembly to “snap” into the slot 308. In this regard, once placed into the slot 308, the tabs 36 secure the mounting member 400 in the slot 308. It should be appreciated that more than one or two tabs may be used on either side 28 or the end wall 30. It should be further appreciated that instead of tabs, other methods can be used to secure the tilt-latch assembly, within the mounting member 400, such as using adhesives or screws.

Although the invention herein has been described with reference to particular embodiments, it is to be understood that these embodiments are merely illustrative of the principles and applications of the present invention. Moreover, in the preceding description, the terms “upper,” “lower,” “first,” “second,” “top,” “front”, “rear,” “vertical” and “horizontal” and derivatives thereof correspond to the invention shown in FIG. 2, and its various embodiments. However, it is to be appreciated that the present invention may take on various alternative orientations. It is therefore to be understood that numerous modifications may be made to the illustrative embodiments and that other arrangements may be devised without departing from the spirit and scope of the present invention as defined by the appended claims.

### INDUSTRIAL APPLICABILILTY

This invention has applicability in the window assembly industry and in the field of window manufacturing.

1. A window assembly comprising:
a window frame;
a plurality of sash rails joined together to form a window sash, including a first sash rail joined to a second sash rail to form a corner, said plurality of sash rails each having a front wall, a rear wall, and an outer wall;
a slot located on said outer wall of said first sash rail a predetermined distance away from said corner so as to provide a lip in said outer wall, said lip reinforcing said outer wall so as to hold together said front wall and said rear wall; and
a tilt-latch assembly arranged and constructed to be mounted in said slot and having a latch member which extends beyond said second sash rail to engage said window frame.

2. A window assembly according to claim 1, wherein said tilt-latch assembly further comprises:
a mounting member, said mounting member comprising a top plate having a first side and a second side, said top plate having a first parallel wall and a second parallel wall projecting from said second side of said top plate to define therewith a channel, and
said latch member disposed in said channel for sliding movement relative to said top plate of said mounting member so as to engage said window frame.

3. A window assembly according to claim 2, wherein a first notch is located in said first parallel wall and a second notch is located in said second parallel wall to receive said lip.

4. A window assembly according to claim 2, wherein said latch member further comprises an angular nose for engaging said window frame.

5. A window assembly according to claim 4, wherein said angular nose has a thickness which approximates the spacing between said first parallel wall and said second parallel wall.

6. A window assembly according to claim 2, wherein said latch member further comprises a stem for receiving a biasing means.

7. A window assembly according to claim 2, wherein said tilt-latch assembly further comprises a control knob to control said sliding movement of said latch member relative to said top plate of said mounting member.

8. A window assembly according to claim 2, wherein said tilt-latch assembly further comprises a biasing means acting between said mounting member and said latch member for biasing said latch member.

9. A window assembly according to claim 8, wherein said biasing means is a spring.

10. A window assembly according to claim 8, wherein said biasing means is positioned between said latch member and said mounting member.

11. A window assembly according to claim 2, wherein said mounting member further comprises at least one tab located on said first parallel wall for securing said tilt-latch assembly in said outer wall of said first sash rail.

12. A window assembly according to claim 2, wherein a bottom plate connects a portion of said first parallel wall and said second parallel wall projecting from the second side of said top plate.

13. A window assembly according to claim 2, further including a semi-circular end wall joining said first parallel wall and said second parallel wall.

14. A window assembly according to claim 13, wherein said mounting member further comprises at least one tab on said semi-circular end wall for securing said tilt-latch assembly in said outer wall of said first sash rail.

15. A window assembly according to claim 2, wherein said top plate is in the shape of a T.

16. A window assembly according to claim 2, wherein said top plate is in the shape of a rectangle.

17. A window sash and at least one tilt-latch assembly for releasably retaining said window sash in a window frame, said window sash further comprising:
at least one horizontal sash rail;
at least one vertical sash rail connected to said horizontal sash rail;
a corner formed at the connection of said at least one horizontal sash rail and at least one vertical sash rail;
said at least one horizontal sash rail comprising a front wall, a rear wall, and an outer wall; and
a slot in said outer wall of said at least one horizontal sash rail for receiving said tilt-latch assembly, said slot located a predetermined distance away from said corner so as to provide a lip between said corner and said slot, said lip reinforcing said top wall so as to hold together said front wall and said rear wall of said at least one horizontal sash rail;
said at least one tilt-latch assembly being arranged and constructed so as to be mounted in said slot and having a latch member which extends beyond said second sash rail to engage said window frame.

18. A window assembly according to claim 17, wherein said tilt-latch assembly further comprises:
a mounting member, said mounting member comprising a top plate having a first side and a second side, said top plate having a first parallel wall and a second parallel wall projecting from said second side of said top plate to define therewith a channel,
said latch member disposed in said channel for sliding movement relative to said top plate of said mounting member so as to engage said window frame.

19. A window assembly according to claim 18, wherein a first notch is located in said first parallel wall and a second notch is located in said second parallel wall to receive said lip.

20. A window assembly according to claim 18, wherein said latch member further comprises an angular nose for engaging said window frame.

21. A window assembly according to claim 20, wherein said angular nose has a thickness which approximates the spacing between said first parallel wall and said second parallel wall.

22. A window assembly according to claim 18, wherein said tilt-latch assembly further comprises a control knob to control said sliding movement of said latch member relative to said top plate of said mounting member.

23. A window assembly according to claim 18, wherein said tilt-latch assembly further comprises a biasing means acting between said mounting member and said latch member for biasing said latch member.

24. A window assembly according to claim 18, wherein said latch member further comprises a stem for receiving a biasing means.

25. A window assembly according to claim 23, wherein said biasing means is a spring.

26. A window assembly according to claim 23, wherein said biasing means is positioned between said latch member and said mounting member.

27. A window assembly according to claim 18, wherein said mounting member further comprises at least one tab located on said first parallel wall for securing said tilt-latch assembly in said outer wall of said first sash rail.

28. A window assembly according to claim 18, wherein a bottom plate connects a portion of the first parallel wall and second parallel wall projecting from the second side of said top plate.

29. A window assembly according to claim 18, further including a semi-circular end wall joining said first parallel wall and said second parallel wall.

30. A window assembly according to claim 29, wherein said mounting member further comprises at least one tab on said semi-circular end wall for securing said tilt-latch assembly in said outer wall of said horizontal sash rail.

31. A window assembly according to claim 18, wherein said top plate is in the shape of a T.

32. A window assembly according to claim 18, wherein said top plate is in the shape of a rectangle.
